(19) United States
(12) Patent Application Publication
(10) Pub. No.: US 2011/0162945 A1
(43) Pub. Date: Jul. 7, 2011

(54) Self-luminescence keypad structure

(76) Inventor: Kuo-Long Chen, Taoyuan (TW)

(21) Appl. No.: 12/700,727

(22) Filed: Feb. 5, 2010

(30) Foreign Application Priority Data
Jan. 6, 2010 (TW) 099200183

(51) Int. Cl. H01H 9/16

(52) U.S. Cl. 200/314

(57) ABSTRACT

The self-luminescence keypad structure includes a backlight module and a self-luminescence keycap structure including a self-luminescence material. For example, a self-luminescence layer comprising the self-luminescence material is disposed, at least a member of the self-luminescence keycap structure is allowed to include the self-luminescence material, or a hard coat including the self-luminescence material is coated on the surface, thereby the keypad structure has the self-luminescence function upon receiving a light from the backlight module. Accordingly, in the dark, the figures on keycaps can be seen even though the backlight is turned off, and thus the electrical power saving can be achieved and the battery lifetime can be increased.

### BACKGROUND OF THE INVENTION

1. Field of the Invention

The present invention relates to a keypad structure, and particularly to a self-luminescence keypad structure, which can self-luminesce by receiving light emitted from the backlight module of the keypad structure.

2. Description of the Prior Art

Electronic products such as cell phones (or mobile phones), personal digital assistants (PDAs) and the like usually have keypads disposed on them. In present market, keypads are mainly categorized into metal keypads and plastic keypads, and the latter are used more commonly. There are figures such as numerals, symbols and English letters on the keypads. Backlight modules such as light emitting diodes (LEDs) are usually disposed under the keypads to provide illumination for keypads, thus it is convenient for users to use in the dark. However, in order to save electrical power of battery, a function item for automatically turning off the illumination is provided, so users can set the illumination duration as desired. The longer the light is turned on, the more quickly the electrical power is consumed. But, consumers usually expect that electrical power of electronic products can last as long as possible.

Taiwan patent number M271245 discloses a photosensitive keypad as shown in FIG. 1. It has a keypad body 10, a photosensitive color layer 12 disposed at the bottom side of the keypad body 10, and a plurality of figures such as letters, symbols and the like located on the photosensitive color layer 12. The photosensitive color layer 12 has a first color change upon receiving a light energy and then a second color change upon receiving another light energy, or more, to achieve dual mode visual effect. It is characterized in providing keypad appearance with various color changes and multiple visual effect, to overcome conventional disadvantages of keypads about having just a fixed color or single color change. Therefore, it can be known that the photosensitive color layer 12 is used for causing color change of the appearance, but not for providing light to reach the backlight function.

Nevertheless, due to continuous development of power saving of electronic products, there is still a need for a novel power saving keypad structure.

### SUMMARY OF THE INVENTION

An objective of the present invention is to provide a self-luminescence keypad structure having the self-luminescence function, and luminescence may be emitted after the keypad absorbs a light from the backlight module; therefore, the self-luminescence keypad structure can save electrical power.

The self-luminescence keypad structure according to the present invention includes a printed circuit board, a metal dome disposed above the printed circuit board, a plunger located above the metal dome, a backlight module located above the printed circuit board to provide a first light, and a self-luminescence keycap structure located above the backlight module and corresponding to the plunger, wherein the self-luminescence keycap structure includes a self-luminescence material. As the backlight module provides the first light, the self-luminescence material absorbs the first light and emits a second light. As the backlight module stops providing the first light, the self-luminescence material continues emitting the second light.

In addition to the backlight module, the self-luminescence keypad structure of the present invention has the members, components, elements or parts in the keycap of the keypad structure, any of which is allowed to have the self-luminescence material. Therefore, after the backlight module is turned off to stop providing light, the self-luminescence keypad structure still can emit luminescence for a while, for serving as a backlight of the keypad. For example, while the cell phone rings in the dark, the self-luminescence keypad structure can absorb the light emitted from the light source (such as LED) to achieve the self-luminescence effect, and then the figures of the keypad can be seen clearly. The electrical power can be accordingly saved, and the usable time of the battery after one charge can be increased, such that the lifetimes of both the battery and the light source can be prolonged.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic diagram illustrating a conventional keypad color;

FIG. 2 shows a schematic diagram according to an embodiment of an application of the keypad structure of the present invention to a cell phone; and

FIGS. 3 to 5 show schematic diagram illustrating some embodiments of the keycap structures of the present invention.

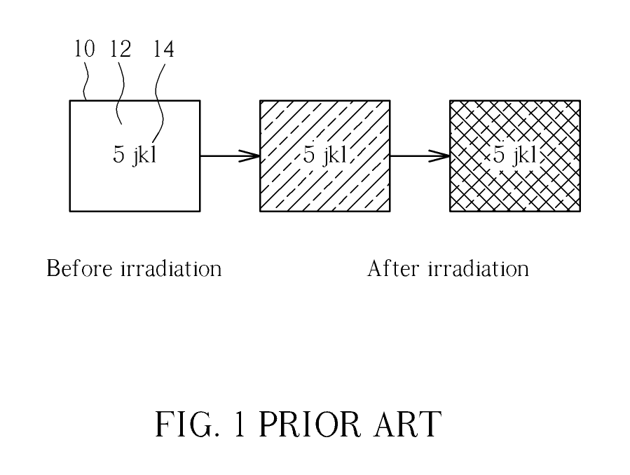

### DETAILED DESCRIPTION

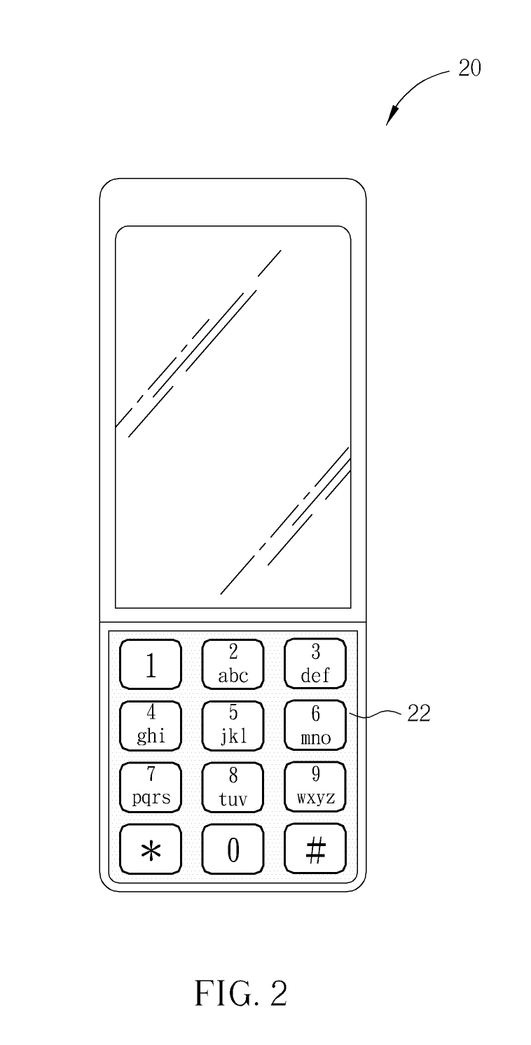

According to the self-luminescence keypad structure of the present invention, a self-luminescence keycap structure includes a self-luminescence material. For example, a self-luminescence material layer can be inserted into the self-luminescence keycap structure, at least a member of the self-luminescence keycap structure is allowed to include the self-luminescence material, or a hard coating including the self-luminescence material is coated on the surface, thereby the keypad structure performs the self-luminescence function upon receiving a light from the backlight module. The keycap structure is not especially limited, which may be a keycap structure composed of plastic and rubber, or formed by injection molding, UV (ultraviolet)-light curing, or lithography, for example. The self-luminescence material may comprise rare earth materials, but is not limited to these. Other materials, such as fluorescence materials, phosphorescence materials, and the like, able to emit light after receiving irradiation, which can be blended into materials of the members of the keypads, or can be alone or blended into other materials such as plastic or coating materials to form a lamella or a coating layer, may be usable in the present invention. FIG. 2 shows the self-luminescence keypad structure 22 of the present invention being used in a cell phone 20.

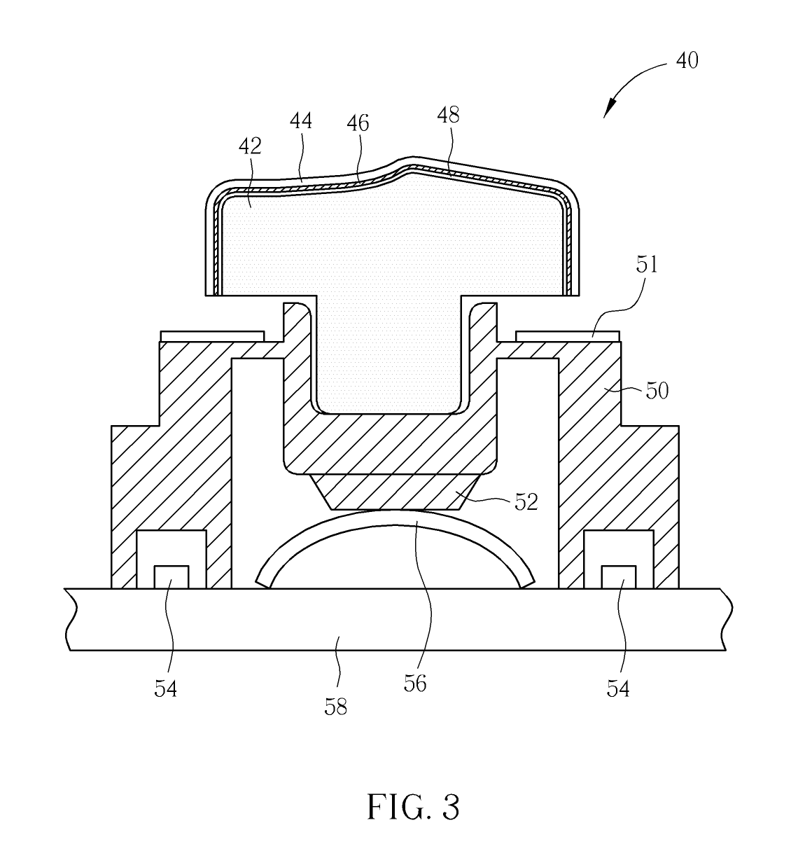

FIG. 3 to FIG. 5 respectively show three embodiments according to the present invention, but the present invention is not limited thereto. An embodiment according to the present invention is shown in FIG. 3. The self-luminescence keypad structure 40 of an embodiment according to the present invention includes a self-luminescence keycap structure including a keycap layer 42, a plastic film 44 and a self-luminescence material layer 46. The keycap layer 42, which is in a keycap shape, may comprise a material which may be a transparent resin such as polycarbonate (PC), poly (ethylene terephthalate) (PET), or a transparent blend composed of acrylonitrile butadiene styrene (ABS) resin and a variety of resins, in some embodiments. The transparent blend may be, for example, a transparent ABS resin formed through blending ABS resin and polymethylmethacrylate (PMMA). Herein, the term “transparent” may mean transparent, translucent, light-penetratable, or light-transmissive. Thus, transparent or hollowed-out materials or members are all referred to as being transparent, and the color thereof is not particularly limited. The plastic film 44 conformally covers the top surface of the keycap layer 42, wherein the plastic film 44 may be a film having plasticity, such as a PC film or the like. The self-luminescence material layer 46 is located between the keycap layer 42 and the plastic film 44. The self-luminescence material layer 46 is formed through mixing a self-luminescence material and a plastic or coating material, for example, mixing a rare earth material and a PC material; or, optionally, the self-luminescence material layer 46 may further include an adhesive material for serving an adhesive layer as well. A print layer 48 may be optionally disposed between the plastic film 44 and the keycap layer 42, to provide the keypad with figures such as background colors, letters, symbols or the like. In this embodiment, the print layer 48 is disposed between the self-luminescence material layer 46 and the keycap layer 42, but not limited thereto. For example, the print layer 48 also can be disposed between the self-luminescence material layer 46 and the plastic film 44. An elastomer layer 50 may be further disposed under the keycap structure, and it may be rubber to provide elasticity. In this embodiment, the elastomer layer 50 and a plunger 52 may be monolithically formed.

The backlight module 54 is located under the elastomer layer 50 to provide light. The keycap layer 42, the plastic film 44, and the optional print layer 48 are transparent. As the backlight module 54 is turned on to provide light, the self-luminescence material layer 46 absorbs the light to emit luminescence. As the backlight module 54 is turned off to stop providing light, the self-luminescence material layer 46 can continue emitting luminescence for a while because of the self-luminescence function. Therefore, the luminescence emitted from the self-luminescence material layer 46 can serve as the backlight of the keypad structure, so that the figures of the keypad can be seen for an increased time period without consuming extra electrical power, and the effect of power saving is achieved.

Since the whole self-luminescence keycap structure is substantially transparent, a light shielding layer 51 may be allowed to be further disposed on the top surface of the elastomer layer 50 to block the light emitted from the backlight module 54, while exposing the keytop. Thus the light is just emitted through the keytop to outside. Under the elastomer layer 50 and the plunger 52, a dome 56 is disposed correspondingly to the location of the plunger 52. The materials of the dome 56 may be metal or conductive plastic, and a printed circuit board 58, preferably a flexible printed circuit board, is disposed under the dome 56. The dome 56 may be fixed on the printed circuit board 58 by using a dome sheet, for example.

The self-luminescence material layer 46 in the aforementioned embodiment is located between the keycap layer 42 and the plastic film 44. However, optionally, the self-luminescence material layer 46 may be located under the keycap layer 42, or the self-luminescence material layer 46 may be coated on the top surface of the plastic film 44 by a coating method.

Alternatively, at least a member of the self-luminescence keycap structure may be allowed to include the self-luminescence material, instead of disposing the self-luminescence material layer 46. For instance, by blending the self-luminescence material in the materials of the keycap layer 42 or the plastic film. 44, the resulted keycap layer 42 or the plastic film 44 will include the self-luminescence material. The blending amount of the self-luminescence material depends on the materials of members of the keycap structure and the desired intensity of luminescence.

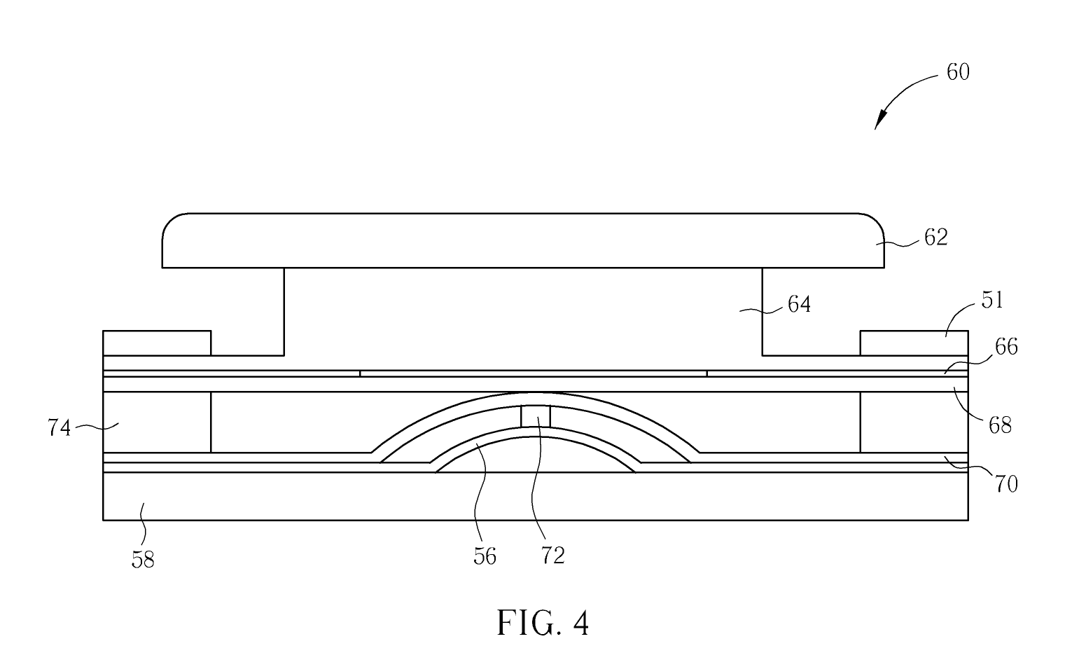

Another embodiment according to the present invention is shown in FIG. 4. The keycap structure of the self-luminescence keypad structure 60 includes a key-shaped layer 62 and an elastomer layer 64 located under the key-shaped layer 62, both of them are transparent. For example, the material of the key-shaped layer 62 may be PC or ABS, and the material of the elastomer layer 64 may be TPU. Both may combine with each other by a co-molding process. The material of the key-shaped layer 62 or the material of the elastomer layer 64 can be blended with the self-luminescence material (such as a rare earth material), so that the key-shaped layer 62 or the elastomer layer 64 can include the self-luminescence material.

A print layer 66 may be further disposed at the bottom surface of the elastomer layer 64 to show figures. The print layer 66 is preferred to be light-penetratable to assist the self-luminescence material absorbing light. An elastomer layer 68 may be further disposed under the print layer 66, which may be a rubber material for example to provide elasticity. A light guide plate 70 is located under the elastomer layer 68 and a light source (not shown) is located on a side or under light guide plate 70, forming a backlight module to provide light. A light shielding layer 51 is further disposed on the top surface of the elastomer layer 68 to block the light emitted from the backlight module, but expose a portion of the keycap. A plunger 72 is disposed under the light guide plate 70 correspondingly to the position of the key, a dome 56 is disposed under the plunger 72, and a printed circuit board 58 is disposed under the dome 56. The dome 56 may be fixed on the printed circuit board 58 by using a dome sheet. Besides, as shown in FIG. 4, the elastomer layer 68 and the light guide plate 70 located on the printed circuit board 58 may be bonded together by an adhesive layer 74.

In this embodiment, one or both of the key-shaped layer 62 and the elastomer layer 64 are allowed to include the self-luminescence material, as to having self-luminescent properties. Nevertheless, forming an aforementioned self-luminescence material layer located between the key-shaped layer 62 and the elastomer layer 64 or under the elastomer layer 64 is also allowed. Alternatively, the self-luminescence material layer may be coated on the top surface of the key-shaped layer 62 by means of coating.

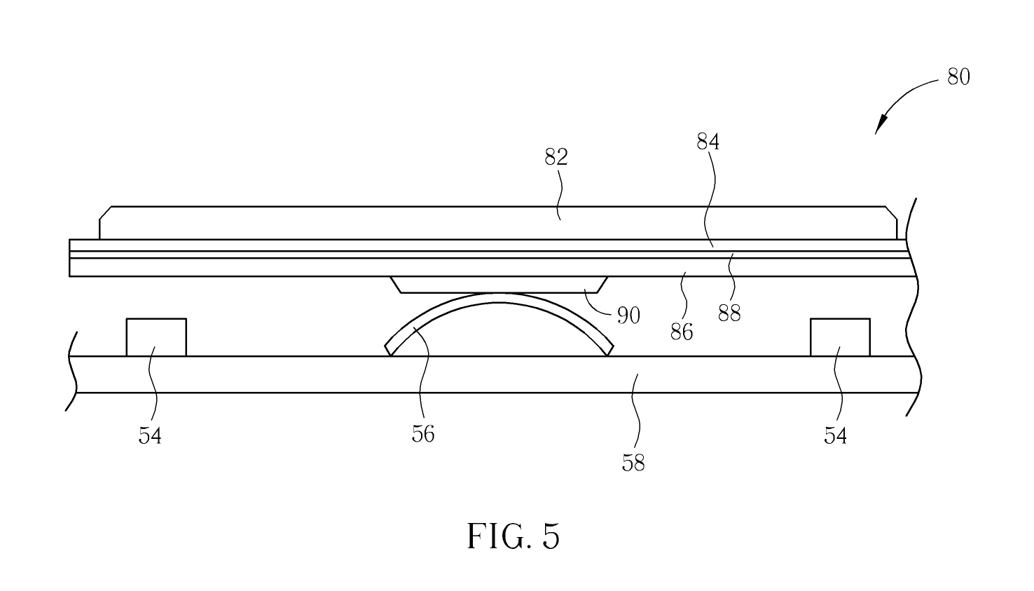

Another embodiment according to the present invention is shown in FIG. 5. The self-luminescence keycap structure of the self-luminescence keypad structure 80 includes a thin type key-shaped layer 82, a plastic base film 84 and an elastomer layer 86, wherein these three members are transparent. The thin type key-shaped layer 82 is formed through a UV-light curing process after application of a UV-light curable resin on the plastic base film 84. The plastic base film 84 may include a PET material, for example. A print layer 88 can be disposed at the bottom surface of the plastic base film 84 to reveal figures. An elastomer layer 86 is disposed under the print layer 88, wherein the elastomer layer 86 may be a rubber material for example to provide elasticity. Blending the self-luminescence material in the materials of the thin type key-shaped layer 82, the plastic base film 84 or the elastomer layer 86 is allowed, to make the thin type key-shaped layer 82, the plastic base film 84 or the elastomer layer 86 include the self-luminescence material.

A plunger 90 can be monolithically formed with the elastomer layer 86. A dome 56 is disposed under the plunger 90 and the printed circuit board 58 is disposed under the dome 56. Furthermore, the dome 56 is fixed on the printed circuit board 58 by a dome sheet (not shown). The light source 54 is disposed on the printed circuit board 58.

In this embodiment, at least one or more of the thin type key-shaped layer 82, the plastic base film 84 and the elastomer layer 86 is allowed to include the self-luminescence material, as to having self-luminescent properties. However, optionally, an aforementioned self-luminescence material layer 46 may be formed to be located between the plastic base film 84 and the elastomer layer 86 or under the elastomer layer 86. Alternatively, the self-luminescence material layer can be coated on the top surface of the thin type key-shaped layer 82 by a coating method.

In another embodiment, the self-luminescence keycap structure is allowed to include a key-shaped layer formed by a lithography process, and the key-shaped layer includes the self-luminescence material, as to having the self-luminescence function.

Those skilled in the art will readily observe that numerous modifications and alterations of the device and method may be made while retaining the teachings of the invention.

What is claimed is:

1. A self-luminescence keypad structure comprising:
a printed circuit board;
a metal dome disposed above the printed circuit board;
a plunger disposed above the metal dome;
a backlight module disposed above the printed circuit board to provide a first light; and
a self-luminescence keycap structure disposed correspondingly to the plunger and above the backlight module, wherein the self-luminescence keycap structure comprises a self-luminescence material, the self-luminescence material absorbs the first light provided by the backlight module to emit a second light, and the self-luminescence material continues emitting the second light when the backlight module stops providing the first light.

2. The self-luminescence keypad structure of claim 1, wherein the backlight module comprises:
a light guide plate disposed between the self-luminescence keycap structure and the plunger; and
a light source disposed beside or under the light guide plate to emit the first light into the light guide plate to provide the first light through the light guide plate.

3. The self-luminescence keypad structure of claim 1, wherein the self-luminescence keycap structure comprises:
a keycap layer which is transparent;
a plastic film which is transparent and covers an upper surface of the keycap layer; and
a self-luminescence material layer disposed between the keycap layer and the plastic film or under the keycap layer, wherein the self-luminescence material layer comprises the self-luminescence material.

4. The self-luminescence keypad structure of claim 3, wherein the self-luminescence material layer further comprises an adhesive material to further serve as an adhesive layer.

5. The self-luminescence keypad structure of claim 3, wherein the self-luminescence keycap structure further comprises a print layer disposed between the keycap layer and the self-luminescence material layer or between the self-luminescence material layer and the plastic film.

6. The self-luminescence keypad structure of claim 1, wherein the self-luminescence keycap structure comprises:
a keycap layer which is transparent; and
a plastic film which is transparent and covers an upper surface of the keycap layer,
wherein the keycap layer or the plastic film comprises the self-luminescence material.

7. The self-luminescence keypad structure of claim 6, wherein the self-luminescence keycap structure further comprises a print layer which is light-penetratable and disposed between the keycap layer and the plastic film.

8. The self-luminescence keypad structure of claim 1, wherein the self-luminescence keycap structure comprises:
a key-shaped layer which is transparent; and
an elastomer layer which is transparent and disposed under the key-shaped layer,
wherein the key-shaped layer or the elastomer layer comprises the self-luminescence material.

9. The self-luminescence keypad structure of claim 8, wherein the key-shaped layer and the elastomer layer combine with each other through a co-molding process.

10. The self-luminescence keypad structure of claim 8, wherein the self-luminescence keycap structure further comprises a print layer which is light-penetratable and disposed under the elastomer layer.

11. The self-luminescence keypad structure of claim 1, wherein the self-luminescence keycap structure comprises:
a key-shaped layer which is transparent;
an elastomer layer which is transparent and disposed under the key-shaped layer; and
a self-luminescence material layer disposed between the key-shaped layer and the elastomer layer or under the elastomer layer, wherein the self-luminescence material layer comprises the self-luminescence material.

12. The self-luminescence keypad structure of claim 11, wherein the self-luminescence material layer further comprises an adhesive material to further serve as an adhesive layer.

13. The self-luminescence keypad structure of claim 11, wherein the key-shaped layer and the elastomer layer combine with each other through a co-molding process.

14. The self-luminescence keypad structure of claim 11, wherein the self-luminescence keycap structure further comprises a print layer which is light-penetratable and disposed under the elastomer layer.

15. The self-luminescence keypad structure of claim 1, wherein the self-luminescence keycap structure comprises:
a thin type key-shaped layer which is transparent;
a plastic base film which is transparent, wherein the thin type key-shaped layer is formed through applying a UV-light curable resin on the plastic base film and curing the UV-light curable resin by a UV light; and
an elastomer layer which is transparent and disposed under the plastic base film,
wherein the thin type key-shaped layer, the plastic base film or the elastomer layer comprises the self-luminescence material.

16. The self-luminescence keypad structure of claim 15, wherein the self-luminescence keycap structure further comprises a print layer which is transparent and disposed between the plastic base film and the elastomer layer.

17. The self-luminescence keypad structure of claim 1, wherein the self-luminescence keycap structure comprises:
a thin type key-shaped layer which is transparent;
a plastic base film which is transparent, wherein the thin type key-shaped layer is formed through applying a UV-light curable resin on the plastic base film and curing the UV-light curable resin by a UV light;
an elastomer layer which is transparent and disposed under the plastic base film; and
a self-luminescence material layer disposed between the plastic base film and the elastomer layer or under the elastomer layer, wherein the self-luminescence material layer comprises the self-luminescence material.

18. The self-luminescence keypad structure of claim 17, wherein the self-luminescence keycap structure further comprises a print layer which is light-penetratable and disposed between the plastic base film and the elastomer layer.

19. The self-luminescence keypad structure of claim 17, wherein the self-luminescence material layer further comprises an adhesive material to further serve as an adhesive layer.

20. The self-luminescence keypad structure of claim 1, wherein the self-luminescence keycap structure comprises a surface coat comprising the self-luminescence material.

21. The self-luminescence keypad structure of claim 1, wherein the self-luminescence keycap structure comprises a key-shaped layer formed through a lithography process, wherein the key-shaped layer comprises the self-luminescence material.
